(19) United States
(12) Patent Application Publication
(10) Pub. No.: US 2012/0018983 A1
(43) Pub. Date: Jan. 26, 2012

(54) INDEPENDENT HYDRAULIC SERVO DRIVE STEERING FOR BETWEEN-THE-DUALS DIRECT DRIVE EQUALIZING BEAM SUSPENSION

(75) Inventor: Leo P. Oriet, Rochester Hills, MI (US)

(73) Assignee: NAVISTAR CANADA, INC., Warrenville, IL (US)

(21) Appl. No.: 13/097,283

(22) Filed: Apr. 29, 2011

Related U.S. Application Data
(63) Continuation-in-part of application No. PCT/US10/43091, filed on Jul. 23, 2010.

(51) Int. Cl. B60G 5/02

(52) U.S. Cl. 280/676

(57) ABSTRACT

A tandem axle (TA) has identical right and left halves, each having a walking beam (9) for suspending the respective half from a chassis frame. A front axle (FA) is at a front of the walking beam and a rear axle (RA) at the rear. Each axle has a carrier carrying a direct wheel drive mechanism having a direct drive motor (6) that drives inboard and outboard wheel hubs (3). A front steering motor (14) mounted on the walking beam has a shaft (14S) coupled to the front axle carrier for steering the front axle, and a rear steering motor (13) steers the rear axle. Each carrier carries its direct wheel drive mechanism in a manner that allows the inboard wheel hub to swing upward along an arc while the outboard wheel hub swings downward along an arc, and the outboard wheel hub to swing upward along an arc while the inboard wheel hub swings downward along an arc.

### TECHNICAL FIELD

This disclosure relates to a tandem axle truck vehicle such as a commercial or military tractor or other like vocational vehicle, relating particularly to the tandem axle itself.

### BACKGROUND OF THE DISCLOSURE

Commercially produced tandem axle truck vehicles are steered by steerable front wheels controlled by steering systems comprising steering wheels which are turned by drivers of the vehicles. The turning radius of such a vehicle depends on where the rigid front axle that contains the steerable front wheels is located in relation to the tandem rear axle and how far inboard and outboard the front wheels can be turned.

A vehicle's turning radius determines how well it, and any trailer load it may be towing, can be maneuvered both in confined spaces, such as when backing a trailer into a loading/unloading dock, and when operating on winding roads having sharp turns. A vehicle's maneuverability may be a factor in a potential customer's decision to purchase it.

### SUMMARY OF THE DISCLOSURE

The disclosed tandem axle provides vehicle maneuverability via a right tandem axle half comprising a right walking beam and a left tandem axle half comprising a left walking beam. Each tandem axle half is arranged opposite the other with respect to the sagittal plane of a truck vehicle platform.

Each tandem axle half has a front axle comprising dual wheels at the front of its walking beam and a rear axle comprising dual wheels at the rear of its walking beam. A front direct drive motor, either electric or hydraulic, is disposed between, and drives, the dual wheels of the front axle. A rear direct drive motor, either electric or hydraulic, is disposed between, and drives, the dual wheels of the rear axle.

Each front axle is steered by its own steering motor, either electric or hydraulic, and each rear axle is steered by its own steering motor, also either electric or hydraulic.

The dual wheels of each axle can also oscillate such that an inboard wheel can swing upward along an arc while the outboard wheel swings downward along an arc, and the outboard wheel can swing upward along an arc while the inboard wheel swings downward along an arc.

A disclosed embodiment of tandem axle comprises a right tandem axle half comprising a right walking beam for suspending the right tandem axle half from a vehicle chassis frame and a left tandem axle half comprising a left walking beam for suspending the left tandem axle half from a vehicle chassis frame.

The right tandem axle half comprises a front axle at a front of the right walking beam and a rear axle at a rear of the right walking beam. The left tandem axle half comprises a front axle at a front of the left walking beam and a rear axle at a rear of the left walking beam.

Each front and rear axle comprises a carrier carrying a direct wheel drive mechanism that comprises an inboard wheel hub, an outboard wheel hub, and a drive motor disposed between the inboard wheel hub and the outboard wheel hub for rotating the inboard wheel hub and the outboard wheel hub.

A front steering motor is mounted on the right walking beam and has a shaft coupled to the carrier of the front axle of the right tandem axle half for steering the front axle of the right tandem axle half to the right and to the left.

A rear steering motor is mounted on the right walking beam and has a shaft coupled to the carrier of the rear axle of the right tandem axle half for steering the rear axle of the right tandem axle half to the right and to the left.

A front steering motor is mounted on the left walking beam and has a shaft coupled to the carrier of the front axle of the left tandem axle half for steering the front axle of the left tandem axle half to the right and to the left.

A rear steering motor is mounted on the left walking beam and has a shaft coupled to the carrier of the rear axle of the left tandem axle half for steering the rear axle of the left tandem axle half to the right and to the left.

Each carrier carries its direct wheel drive mechanism in a manner that allows the inboard wheel hub to swing upward along an arc while the outboard wheel hub swings downward along an arc, and that allows the outboard wheel hub to swing upward along an arc while the inboard wheel hub swings downward along an arc.

The foregoing summary, accompanied by further detail, will be presented in the Detailed Description below with reference to the following drawings that are part of this disclosure.

### BRIEF DESCRIPTION OF THE DRAWINGS

FIG. 1 is a top view of a first embodiment of the presently disclosed tandem axle.

FIG. 2 is a front view of FIG. 1, corresponding to a side elevation view when the tandem axle is mounted on a vehicle chassis frame.

FIG. 3 is a top view of a second embodiment of the presently disclosed tandem axle.

FIG. 4 is a front view of FIG. 3.

FIG. 5 is a schematic plan view of a representative vehicle platform including the disclosed tandem axle.

### DETAILED DESCRIPTION

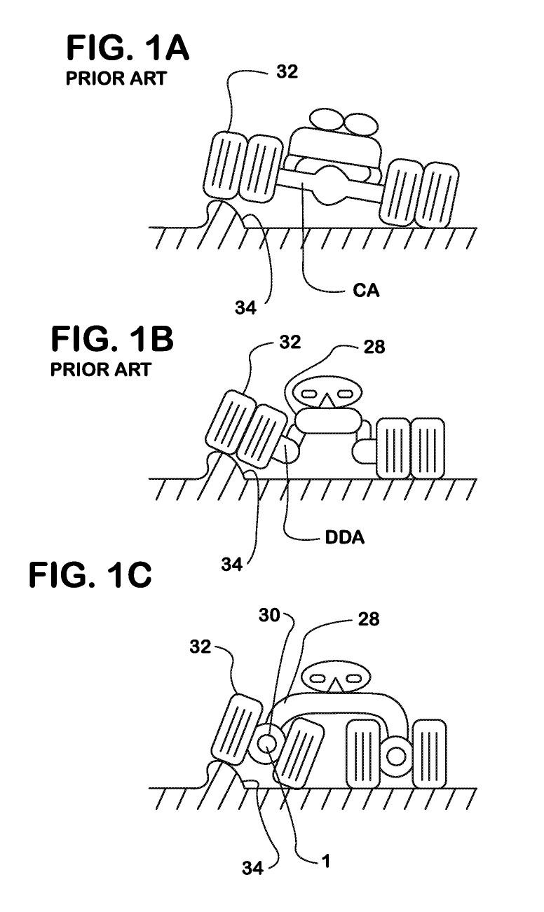

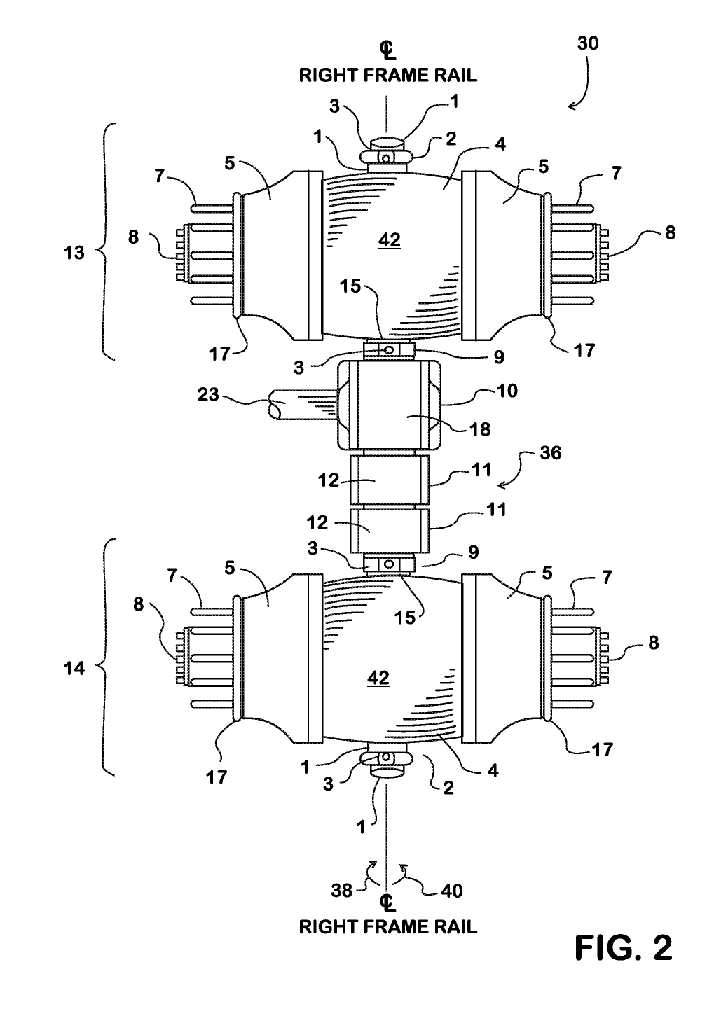

FIGS. 1 and 2 contain components identified as follows: axle driveshaft 1; wheel stud 2; wheel hub 3, drive motor oscillator shaft 4; airbag press lower half 5; direct drive motor 6; airbag press hinge pin 7; walking beam pin 8; walking beam 9; airbag press upper half 10; air bag 11; bearing 12; front hydraulic servo steering motor 14; rear hydraulic servo steering motor 13; threaded fasteners 15; airbag press hard stop 18.

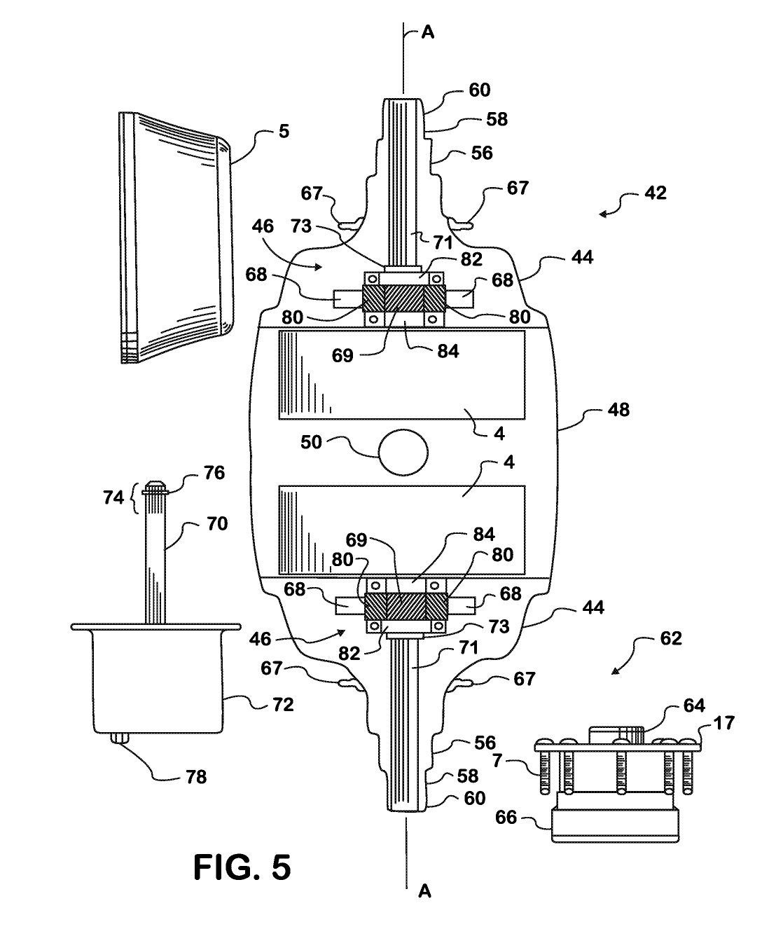

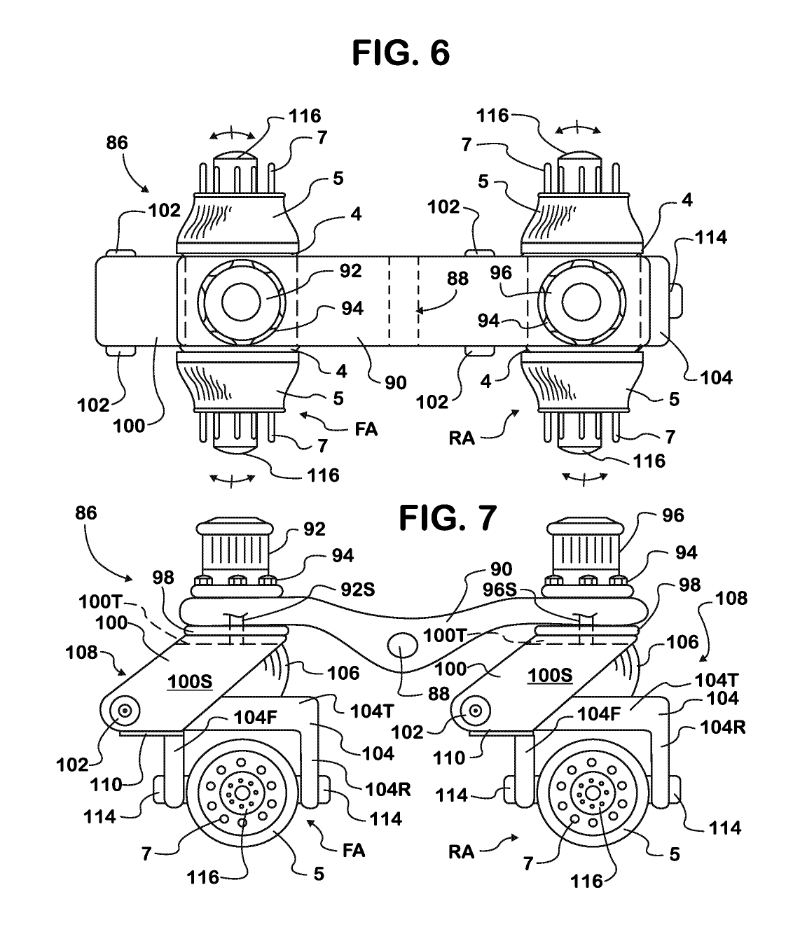

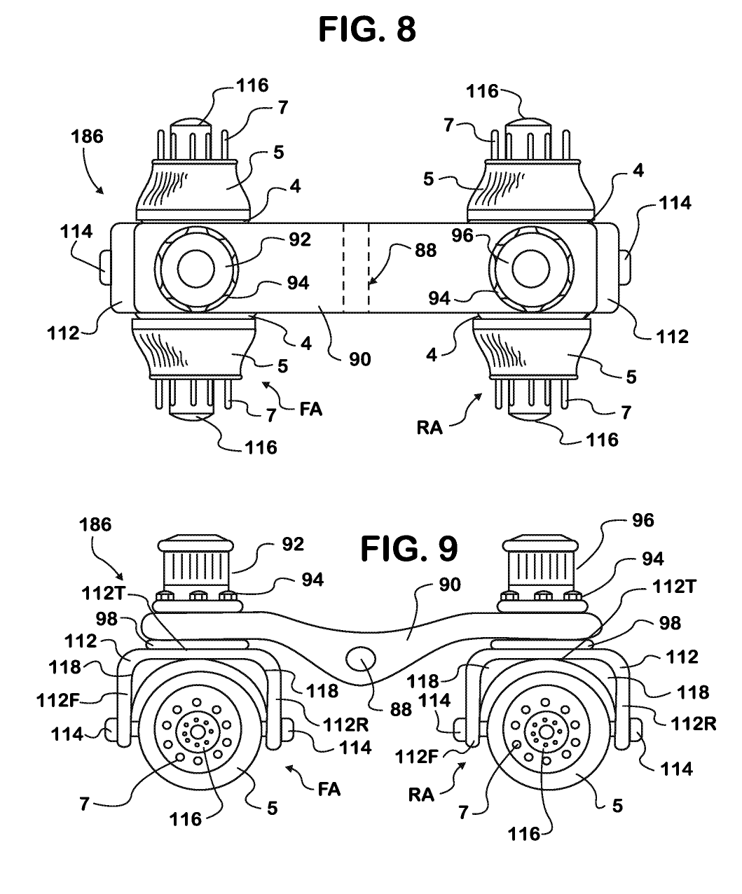

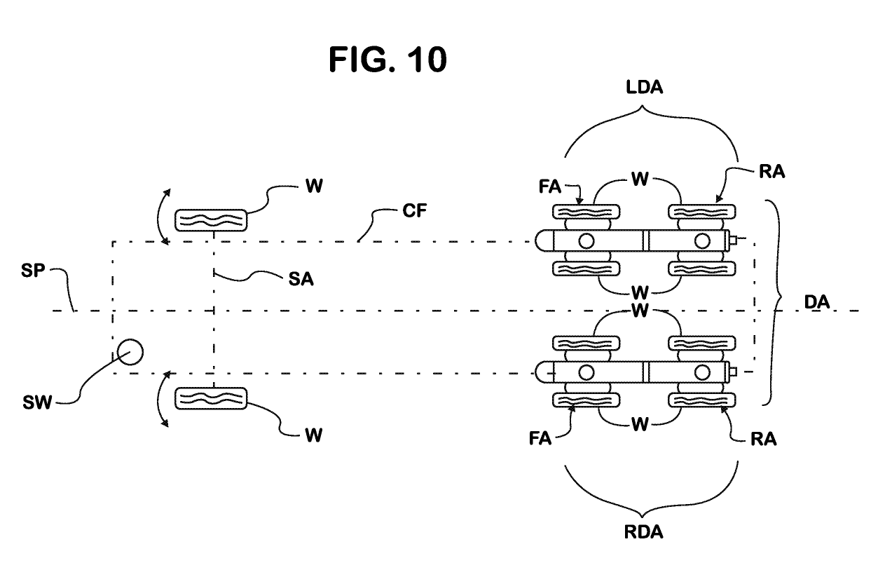

Collectively, the assembled components form one half of a tandem axle TA for a truck vehicle. The other half of the tandem axle is identical to the one shown. Each half is located opposite the other with respect to the sagittal plane of a truck vehicle platform having a chassis frame CF as presented schematically in FIG. 5. The axle toward the left in FIGS. 1 and 2 is either the right half or the left half of a front axle FA of tandem axle TA, and the axle toward the right in FIGS. 1 and 2 is either the right half or the left half of a rear axle RA of tandem axle TA. In the vehicle platform shown in FIG. 5, a front steering axle SA that is forward of tandem axle TA comprises steerable front road wheels W independently driven by their own drive motors (not shown). Tandem axle TA has eight road wheels W.

Pin 8 is disposed centrally at the midpoint of each walking beam 9 between front axle FA and rear axle RA to provide a point of connection of the walking beam to the respective right or left side of the truck chassis frame either directly or through a suspension system. A front hydraulic servo steering motor 14 is disposed on a flat area toward the front of a top surface of walking beam 9 and fastened to the walking beam by threaded fasteners 15. A rear hydraulic servo steering motor 13 is disposed on a flat area toward the rear of the top surface of walking beam 9 and fastened to the walking beam by threaded fasteners 15.

Each hydraulic servo steering motor 13, 14 has a respective vertical shaft 13S, 14S that passes through a respective hole in the walking beam and through a respective bearing 12 to attain a drive connection with a top wall 10T of a respective airbag press upper half 10. The drive connection enables each steering motor to steer each axle to the right or left from the straight steering position shown in the Figures, as will become fully apparent from further description, with each axle being capable of being steered independently of the other.

In addition to top wall 10T, each airbag press upper half 10 also has parallelogram-shaped sidewalls 10S (readily apparent in FIG. 2) that extend horizontally forwardly and vertically downwardly from top wall 10T. Proximate the lower front corner of sidewalls 10S, a respective hinge pin 7 passes through one sidewall 10S, then a top wall 5T of a respective airbag press lower half 5, and then the opposite sidewall 10S.

A respective airbag 11 is disposed between top wall 10T of the respective airbag press upper half 10 and the top wall 5T of the respective airbag press lower half 5, completing an airbag press assembly.

The airbag press assembly that has been described hinges each airbag press lower half 5 for swinging motion about the axis of the respective hinge pin 7 with an airbag 11 captured between the two halves of the press to provide pneumatic damping of motion of each airbag press lower half toward the respective airbag press upper half FIGS. 1 and 2 show a respective hard stop 18 mounted on each airbag press lower half 5 abutting a lower edge of the respective sidewall 10S to establish a limit to which the airbag press lower half 5 can compress the respective air bag. It should therefore be understood that when tandem axle TA is functional in a truck vehicle, the airbag press halves are typically more open than shown in FIG. 2 to allow the airbags to be effective.

Because of the hinged connection of each airbag press lower half 5 to its upper half 10, the former will turn with the latter about the axis of the respective shaft 13S, 14S when the respective motor 13, 14 operates.

Each airbag press lower half 5 also comprises a respective front wall 5F spaced rearward of its hinge pin 7 and extending vertically downward from its top wall 5T and a respective rear wall 5R extending vertically downward at the rear of its top wall 5T. Front wall 5F, rear wall 5R, and the portion of top wall 5T between the two vertical walls cooperatively define a channel having a downwardly open throat.

A respective drive motor oscillator shaft 4 has shaft ends journaled in walls 5F and 5R of the respective airbag press lower half 5 at locations that are below top wall 5T and that render shaft 4 parallel with top wall 5T. Each shaft 4 is thereby supported for oscillation about its own axis by front wall 5F and rear wall 5R. Each oscillator shaft 4 supports the respective direct drive motor 6 from the respective airbag press lower half 5 for concurrent oscillation with the oscillator shaft about the shaft's axis that passes centrally through a housing of a respective direct drive motor 6. Alternately, the oscillator shaft ends may be affixed to walls 5F and 5R with the shaft journaling the housing of the direct drive motor for turning on the shaft.

Each direct drive motor 6 has a respective axle driveshaft 1 that comprises an inboard driveshaft portion and an outboard driveshaft portion. The inboard driveshaft portion extends inboard from the drive motor housing, and the outboard drive shaft portion extends outboard from the drive motor housing. Each inboard drive shaft portion is coupled to an inboard wheel hub 3, and each outboard drive shaft portion is coupled to an outboard wheel hub 3. In this way each direct drive motor 6 is a “between-the-duals” direct drive for the road wheels that it directly drives.

Spiders of road wheels W (FIG. 5) are disposed against open faces of, and fastened to, wheel hubs 3 by tightening wheel nuts (not shown) into wheel studs 2 that extend from hubs 3 through holes in the wheel spiders.

Collectively, each drive motor 13, 14 and the inboard and outboard wheel hubs 3 that it drives form a respective direct wheel drive mechanism that is carried by the respective airbag press assembly via oscillator shaft 4.

When a direct drive motor turns counterclockwise in FIG. 2, its inner and outer driveshaft portions turn counterclockwise to impart forward motion to a vehicle when the vehicle is being steered in a straight line, and when a direct drive motor turns clockwise in FIG. 2, its inner and outer driveshaft portions turn clockwise to impart rearward motion to the vehicle when the vehicle is being steered in a straight line. The direct drive motors can be independently operated, allowing either, both, or neither to propel the vehicle at any given time with each axle FA, RA being independently suspended from its walking beam 9 and being independently steerable. The direct drive motors may also be of the motor/generator type that can recover energy during regenerative braking of a vehicle.

Use of the descriptor “direct” in reference to a direct drive motor and a direct wheel drive mechanism is not meant to imply that the inboard and outboard wheel hubs 3 of an axle must always rotate at the same speed because a single axle 1 extends through the direct drive motor to both wheel hubs. For example a direct wheel drive mechanism may comprises separate inboard and outboard shafts each operated by the same drive motor but turning at slightly different speeds when the axle is being steered to the right or the left due to suitable mechanisms incorporated between the drive motor and the separate shafts or due to a construction for the drive motor that accomplishes the same.

Each front axle FA can swing along an upward arc about the axis of pin 8 while the rear axle RA is swinging along a downward arc about the axis of pin 8, and each rear axle RA can swing along an upward arc about the axis of pin 8 while the front axle FA is swinging along a downward arc about the axis of pin 8. By making the distance between front axle FA and the axis of pin 8 equal to the distance between rear axle RA and the axis of pin 8 as shown in FIGS. 1 and 2, walking beam 9 functions as an equalizing beam because each axle will swing along a respective arc lying on a common circle. By arranging the axis of each oscillator shaft 4 to passes centrally through the housing of the respective direct drive motor 6 equidistant from the dual road wheels that it drives, those road wheels will swing up and down along arcs of a common circle.

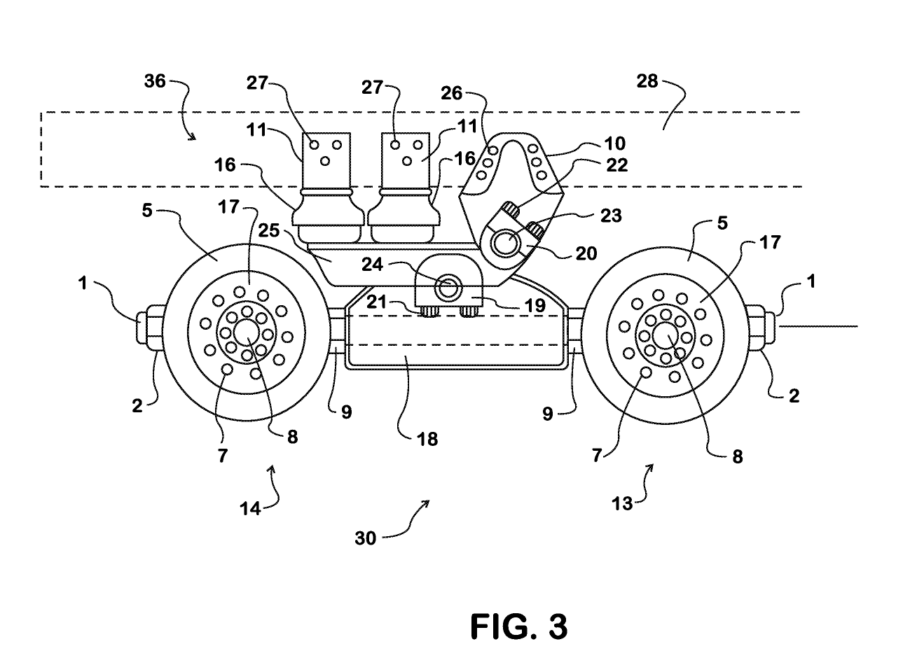

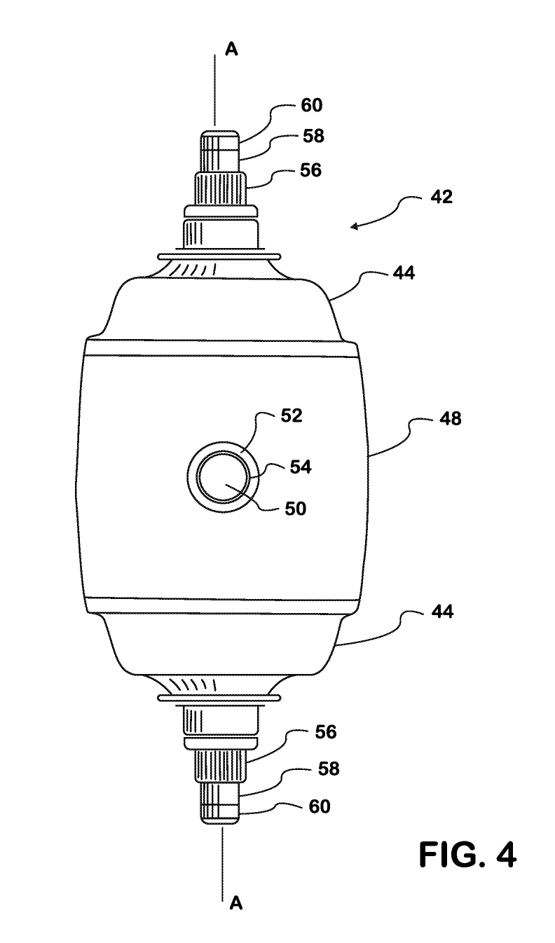

FIGS. 3 and 4 disclose a second embodiment of tandem axle that differs from the embodiment of FIGS. 1 and 2 in that neither axle FA or RA is independently suspended from walking beam 9. Rather the shaft 13S, 14S of each steering motor 13, 14 has a drive connection with a top wall of a channel 16 that like airbag press lower half 5 has front and rear vertical walls 16F, 16R forming a downwardly open throat, but also include gussets 17 at the bends between top wall 16T and vertical walls 16F, 16R. The reference numerals used in FIGS. 1 and 2 identify the same components in FIGS. 3 and 4. Each axle FA, RA in FIGS. 3 and 4 is independently steerable on walking beam 9, each can be independently operated to propel the vehicle, and each can independently oscillate about the axis of its oscillator shaft 4.

In the disclosed embodiments, the various motors may be electric, or hydraulic, or combinations thereof. They may be controlled by a comprehensive electronic control strategy suited for the particular vehicle to navigate various on-road and off-road surfaces. Bearings 12 serve to separate the walking beams from immediately underlying components while bearing load force between them to facilitate axle steering by motors 13, 14.

The disclosed embodiments provide an all-wheel steer walking beam vehicle in which steering is accomplished with the aid of a computer-processor-controlled hydraulic- or electric- servo steering actuator system that performs precise all-wheel vehicle steering front-to-back with high articulation walking beam suspensions. Wheels on each common axle can be steered independently and over ranges for enabling commercial and military vehicles to have near-zero turning radii for negotiating sharp roadway curves and tractor-trailer backing.

What is claimed is:

1. A tandem axle comprising:
a right tandem axle half comprising a right walking beam for suspending the right tandem axle half from a vehicle chassis frame and a left tandem axle half comprising a left walking beam for suspending the left tandem axle half from a vehicle frame;
the right tandem axle half comprising a front axle at a front of the right walking beam and a rear axle at a rear of the right walking beam;
the left tandem axle half comprising a front axle at a front of the left walking beam and a rear axle at a rear of the left walking beam;
each axle comprising a carrier carrying a direct wheel drive mechanism that comprises an inboard wheel hub, an outboard wheel hub, and a drive motor disposed between the inboard wheel hub and the outboard wheel hub for rotating the inboard wheel hub and the outboard wheel hub;
a front steering motor mounted on the right walking beam and having a shaft coupled to the carrier of the front axle of the right tandem axle half for steering the front axle of the right tandem axle half to the right and to the left;
a rear steering motor mounted on the right walking beam and having a shaft coupled to the carrier of the rear axle of the right tandem axle half for steering the rear axle of the right tandem axle half to the right and to the left;
a front steering motor mounted on the left walking beam and having a shaft coupled to the carrier of the front axle of the left tandem axle half for steering the front axle of the left tandem axle half to the right and to the left;
a rear steering motor mounted on the left walking beam and having a shaft coupled to the carrier of the rear axle of the left tandem axle half for steering the rear axle of the left tandem axle half to the right and to the left;
each carrier carrying its direct wheel drive mechanism in a manner that allows the inboard wheel hub to swing upward along an arc while the outboard wheel hub swings downward along an arc, and that allows the outboard wheel hub to swing upward along an arc while the inboard wheel hub swings downward along an arc.

2. The tandem axle as set forth in claim 1 in which each carrier comprises a channel having a top wall and sidewalls that extend downward from the channel's top wall and are spaced apart front-to-rear and, and in which each carrier carries its direct wheel drive mechanism by an oscillator shaft that extends between the channel's sidewalls below the channel's top wall, that allows the inboard wheel hub to swing upward along an arc while the outboard wheel hub swings downward along an arc, and that allows the outboard wheel hub to swing upward along an arc while the inboard wheel hub swings downward along an arc.

3. The tandem axle as set forth in claim 2 in which each oscillator shaft has an axis passing through the respective drive motor.

4. The tandem axle as set forth in claim 2 including a respective bearing separating the top wall of each channel and the respective walking beam while bearing load force between them to facilitate steering by the respective steering motor.

5. The tandem axle as set forth in claim 1 in which each carrier comprises an airbag press having a press upper half, a press lower half, and a hinge that hinges the press upper half and the press lower half together frontally of the shaft of the respective steering motor to allow the press upper half and the press lower half to swing toward and away from each other, and further comprising a respective airbag disposed between each press upper half and the respective press lower half for providing pneumatic damping of motion each press lower half toward the respective press upper half.

6. The tandem axle as set forth in claim 5 in which each press lower half comprises a channel having a top wall and sidewalls that extend downward from the channel's top wall and are spaced apart front-to-rear, and in which each direct wheel drive mechanism is carried by an oscillator shaft that extends between the channel's sidewalls below the channel's top wall, that allows the inboard wheel hub to swing upward along an arc while the outboard wheel hub swings downward along an arc, and that allows the outboard wheel hub to swing upward along an arc while the inboard wheel hub swings downward along an arc.

7. The tandem axle as set forth in claim 6 in which each press upper half comprises a top wall spaced vertically above the top wall of the respective lower press half's top wall, the respective airbag is disposed between the top wall of the respective upper press half and the top wall of the respective lower press half, and the shaft of each steering motor is coupled to the top wall of the respective press upper half.

8. The tandem axle as set forth in claim 7 including a respective bearing separating the top wall of each press upper half and the respective walking beam while bearing load force between them to facilitate steering by the respective steering motor.

9. A vehicle comprising a chassis frame and the tandem axle set forth in claim 1 further including a respective wheel fastened to each wheel hub of the tandem axle, and in which the tandem axle is arranged to support a rear of the chassis frame, and further including a front steering axle comprising steered front wheels supporting a front of the chassis frame forward of the tandem axle.

10. The vehicle set forth in claim 9 including a steering system for controlling steering of the steered front wheels of the front steering axle and steering of the wheels fastened to the wheel hubs of the tandem axle.

11. A tandem axle half comprising:
a walking beam for suspending the tandem axle half from a vehicle chassis frame;
the tandem axle half comprising a front axle at a front of the walking beam and a rear axle at a rear of the walking beam;
each axle comprising a carrier carrying a direct wheel drive mechanism that comprises an inboard wheel hub, an outboard wheel hub, and a drive motor disposed between the inboard wheel hub and the outboard wheel hub for rotating the inboard wheel hub and the outboard wheel hub;
a front steering motor mounted on the walking beam and having a shaft coupled to the carrier of the front axle of the tandem axle half for steering the front axle of the tandem axle half to the right and to the left;
a rear steering motor mounted on the walking beam and having a shaft coupled to the carrier of the rear axle of the tandem axle half for steering the rear axle of the tandem axle half to the right and to the left;
each carrier carrying its direct wheel drive mechanism in a manner that allows the inboard wheel hub to swing upward along an arc while the outboard wheel hub swings downward along an arc, and that allows the outboard wheel hub to swing upward along an arc while the inboard wheel hub swings downward along an arc.

12. The tandem axle half as set forth in claim 11 in which each carrier comprises a channel having a top wall and sidewalls that extend downward from the channel's top wall and are spaced apart front-to-rear and, and in which each carrier carries its direct wheel drive mechanism by an oscillator shaft that extends between the channel's sidewalls below the channel's top wall, that allows the inboard wheel hub to swing upward along an arc while the outboard wheel hub swings downward along an arc, and that allows the outboard wheel hub to swing upward along an arc while the inboard wheel hub swings downward along an arc.

13. The tandem axle half as set forth in claim 12 in which each oscillator shaft has an axis passing through the respective drive motor.

14. The tandem axle half as set forth in claim 12 including a respective bearing separating the top wall of each channel and the walking beam while bearing load force between them to facilitate steering by the respective steering motor.

15. The tandem axle half as set forth in claim 11 in which each carrier comprises an airbag press having a press upper half, a press lower half, and a hinge that hinges the press upper half and the press lower half together frontally of the shaft of the respective steering motor to allow the press upper half and the press lower half to swing toward and away from each other, and further comprising a respective airbag disposed between each press upper half and the respective press lower half for providing pneumatic damping of motion each press lower half toward the respective press upper half.

16. The tandem axle half as set forth in claim 15 in which each press lower half comprises a channel having a top wall and sidewalls that extend downward from the channel's top wall and are spaced apart front-to-rear, and in which each direct wheel drive mechanism is carried by an oscillator shaft that extends between the channel's sidewalls below the channel's top wall, that allows the inboard wheel hub to swing upward along an arc while the outboard wheel hub swings downward along an arc, and that allows the outboard wheel hub to swing upward along an arc while the inboard wheel hub swings downward along an arc.

17. The tandem axle half as set forth in claim 16 in which each press upper half comprises a top wall spaced vertically above the top wall of the respective lower press half's top wall, the respective airbag is disposed between the top wall of the respective upper press half and the top wall of the respective lower press half, and the shaft of each steering motor is coupled to the top wall of the respective press upper half.

18. The tandem axle half as set forth in claim 17 including a respective bearing separating the top wall of each press upper half and the respective walking beam while bearing load force between them to facilitate steering by the respective steering motor.
